(19) United States
(12) Patent Application Publication
(10) Pub. No.: US 2018/0271744 A1
(43) Pub. Date: Sep. 27, 2018

(54) SEXUAL STIMULATION DEVICE

(71) Applicant: Paul Parker, Harvest, AL (US)

(72) Inventor: Paul Parker, Harvest, AL (US)

(21) Appl. No.: 15/936,808

(22) Filed: Mar. 27, 2018

Related U.S. Application Data
(60) Provisional application No. 62/477,031, filed on Mar. 27, 2017.

(51) Int. Cl. A61H 19/00; A61H 23/02

(52) U.S. Cl. CPC A61H 19/34; A61H 2201/5046; A61H 2201/5097; A61H 23/0263

(57) ABSTRACT

The present disclosure relates to a stimulation device for sexual stimulation including a pad assembly including a pad housing having a front side and a back side. A vibrating mechanism can be positioned on the front side of the pad housing, the vibrating mechanism including a motor and a motor controller connected to the motor, the motor controller operable to control the motor and thus vibrations emitted by the vibrating mechanism. A pad can be positioned over and against the vibrating mechanism such that vibrations emitted by the vibrating mechanism are transferred to the pad. The device can be utilized for sexual stimulation for either recreational use or medical use in the treatment of sexual dysfunction.

### CROSS-REFERENCES TO RELATED APPLICATIONS

This application claims priority to and benefit of co-pending U.S. Provisional Patent Application No. 62/477,031, filed Mar. 27, 2017, entitled “Flutter Pad System”, which is herein incorporated by reference in its entirety.

A portion of the disclosure of this patent document contains material that is subject to copyright protection. The copyright owner has no objection to the reproduction of the patent document or the patent disclosure, as it appears in the U.S. Patent and Trademark Office patent file or records, but otherwise reserves all copyright rights whatsoever.

### STATEMENT REGARDING FEDERALLY SPONSORED RESEARCH OR DEVELOPMENT

Not Applicable

### REFERENCE TO SEQUENCE LISTING OR COMPUTER PROGRAM LISTING APPENDIX

Not Applicable

### BACKGROUND OF THE INVENTION

The present disclosure relates generally to stimulation devices for aiding users who experience sexual dysfunction.

Sexual dysfunction is a complex disorder that affects a large segment of the population, both men and women. Sexual dysfunction can be caused by a variety of physical, medical, and psychological factors. Sexual desire begins in the brain and manifests in sexual organs as neurotransmitters in the brain trigger more blood flow to be sent to sexual organs. When depression, anxiety, or other mood disorders are present, neurotransmitters related to sexual desire are inhibited, thereby decreasing the amount of blood flow to the sex organs which can cause low arousal and a tightening of the pelvic region which can result in discomfort or pain during sexual intercourse. Medications as well as diet and other physical conditions can also inhibit sexual desire and cause low arousal.

Stimulation of the sexual organs, such as with vibrations, is known to cause arousal and increased blood flow to the sexual organs, which can help overcome sexual dysfunction. Clitoral stimulation and penile stimulation can increase sexual arousal in women and men respectively. There are a wide variety of such stimulation products on the market. Some such products include undergarments with built in vibration devices. However, such products are specialized such that the vibrating devices are only usable with specific and specially designed undergarments.

What is needed then are improvements to sexual stimulation devices.

### BRIEF SUMMARY

This Brief Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

One aspect of the disclosure is a stimulation device for sexual stimulation with a pad assembly including a pad housing having a front side and a back side. A vibrating mechanism can be positioned on the front side of the pad housing, the vibrating mechanism including a motor and a motor controller connected to the motor operable to control the motor and thus vibrations emitted by the vibrating mechanism. A pad can be positioned over and against the vibrating mechanism such that vibrations emitted by the vibrating mechanism are transferred to the pad. The device can be utilized for sexual stimulation for either recreational use or medical use in the treatment of sexual dysfunction.

In some embodiments, the back side of the pad housing can include a retention element which can help retain the pad housing, and thus a stimulation device, on an undergarment during use of the stimulation device such that the stimulation device can be used in undergarments with or without a pocket for the stimulation device. In one embodiment, the retention element is a reusable adhesive layer which can be repeatedly stuck or secured, and subsequently removed, from an undergarment.

In some embodiments, the stimulation device can also include a remote control that can communicate wireless with the motor controller. The remote control can allow the pad assembly to operate without any wires needing to be run to a remote. Additionally, the wireless remote can allow the stimulation device to be controlled from a distance.

One objective of the present disclosure is to provide a device for sexual stimulation.

Another objective of the present disclosure is to provide a sexual stimulation device that can be controlled remotely through wireless communication protocols.

Another objective of the present disclosure is to provide a sexual stimulation device that can be utilized interchangeably with varying undergarments.

Numerous other objects, advantages and features of the present disclosure will be readily apparent to those of skill in the art upon a review of the following drawings and description of a preferred embodiment.

### BRIEF DESCRIPTION OF THE DRAWINGS

FIG. 1 is a perspective view of an embodiment of a stimulation device of the present disclosure.

FIG. 2 is front elevation view of the stimulation device of FIG. 1.

FIG. 3 is partial exploded perspective view of the stimulation device of FIG. 1.

FIG. 4 is perspective view of a charging port cover of the stimulation device of FIG. 1.

FIG. 5 is a bottom perspective view of a pad of the device of FIG. 1.

FIG. 6 is a side cross-section view of the stimulation device of FIG. 1.

FIG. 7 is a side elevation view of the stimulation device of FIG. 1.

FIG. 8 is a back elevation view of the stimulation device of FIG. 1.

FIG. 9 is a back perspective view of the stimulation device of FIG. 1.

FIG. 10 is a back perspective view of another embodiment of a stimulation device including a reusable adhesive layer on the back side of pad housing of a stimulation device.

FIG. 11 is a top perspective view of the stimulation device of FIG. 1 positioned in an undergarment.

FIG. 12 is a top perspective view of the stimulation device of FIG. 1 positioned in an undergarment having a pocket for the stimulation device.

FIG. 13 is a front elevation view of the stimulation device of FIG. 1 and a remote control in communication with the stimulation device

FIG. 14 is a block diagram of electrical connections in and communications for an embodiment of a stimulation device having an associated remote control.

### DETAILED DESCRIPTION

While the making and using of various embodiments of the present invention are discussed in detail below, it should be appreciated that the present invention provides many applicable inventive concepts that are embodied in a wide variety of specific contexts. The specific embodiments discussed herein are merely illustrative of specific ways to make and use the invention and do not delimit the scope of the invention. Those of ordinary skill in the art will recognize numerous equivalents to the specific apparatus and methods described herein. Such equivalents are considered to be within the scope of this invention and are covered by the claims.

In the drawings, not all reference numbers are included in each drawing, for the sake of clarity. In addition, positional terms such as “upper,” “lower,” “side,” “top,” “bottom,” etc. refer to the apparatus when in the orientation shown in the drawing. A person of skill in the art will recognize that the apparatus can assume different orientations when in use.

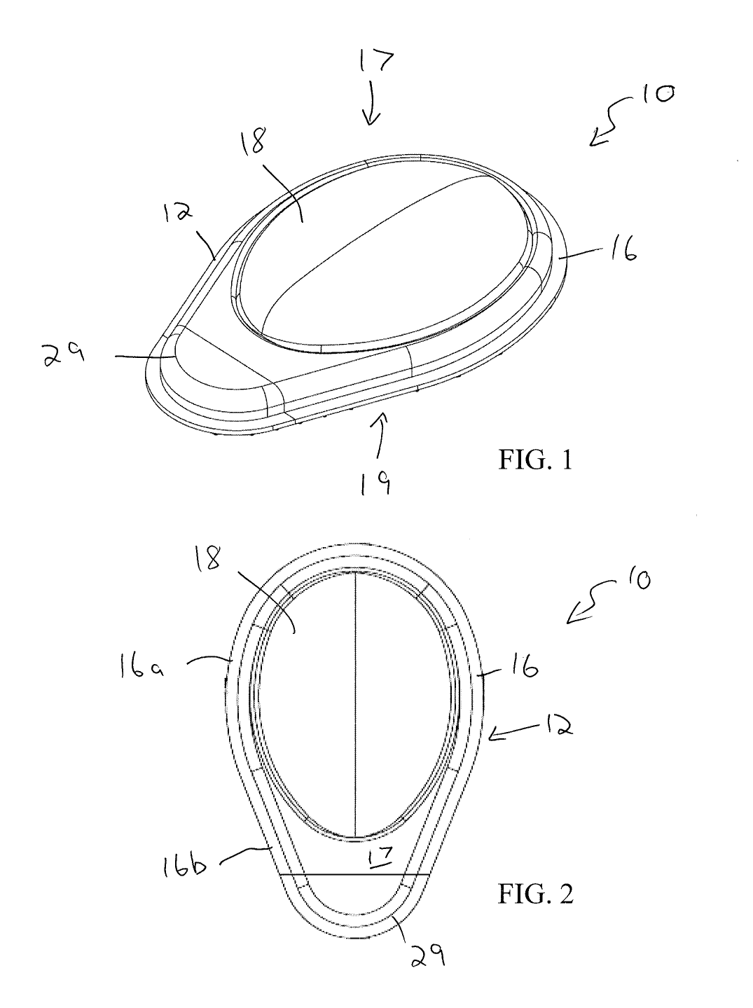

Referring to FIGS. 1-4, one embodiment of a stimulation device 10 of the present disclosure is shown which includes a pad assembly 12. The pad assembly 12 may include a pad housing 16. The pad housing 16 may include a front side 17 and a back side 19. In some embodiments, the pad housing 16 may be manufactured out of rubber, silicone, plastics, polymers, metals, or any other suitable material. The pad housing 16 may be sized and shaped so that it can fit inside the front or pelvic covering section of various undergarments, including thong, brief, bikini, or traditional style undergarments.

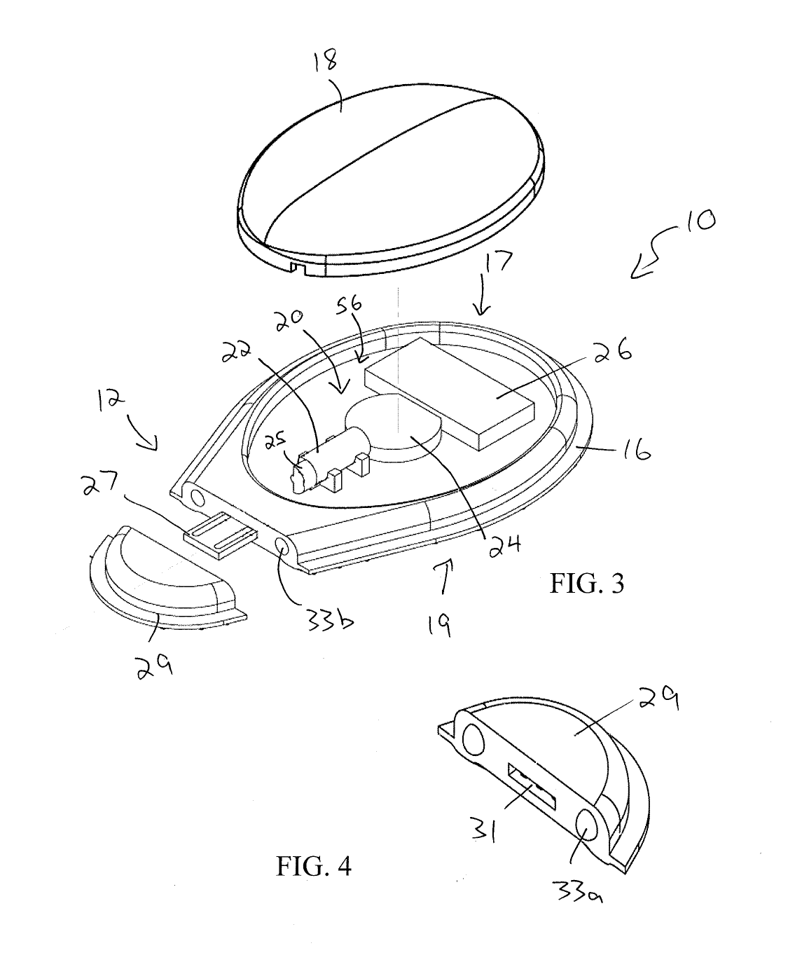

As shown in FIG. 3, the pad assembly 12 may include a vibrating mechanism 20 positioned on a front side 17 of the pad housing 16. The vibrating mechanism 20 can include a motor 22 and a motor controller 24 connected to the motor 22, the motor controller 24 operable to control the motor 22 and thus vibrations emitted by the vibrating mechanism 22. In some embodiments, the motor 22 can be a vibrating motor such as a “coin motor”. The motor 22 can include a motor shaft which is operable to rotate an unbalanced eccentric mass 25. The rotation of the unbalanced eccentric mass 25 can cause the motor 22 to produce a vibrating effect when operated. In other embodiments, the motor 22 can drive a cam, piston, lever, or other suitable structure which can produce a vibrating motion or effect in the cam, piston, lever, etc. The motor 22 may otherwise be any type of motor that vibrates when it receives power, or can be driven to produce a vibration in a related structure. The vibrations of the motor 22 may vary in speed, intensity, and timing depending on the power supplied to the motor 22.

The motor controller 24 can be operable to control the motor 22 to produce various stimulation effects. The motor controller 24 may include a microprocessor, memory, and software that, when executed by the microprocessor, causes the motor controller 26 to generate an output control signal to the motor 22. The motor controller 24 can control the power supplied to the motor 22 and thus the motor's speed. Faster motor speeds can increase the intensity of the vibrating effect of the motor 22. The motor controller 24 can also be operable to produce varying modes of vibrations, for instance a continuous vibrating mode, a pulsating vibrating mode, etc.

The vibrating mechanism 20 in some embodiments can include a motor battery 26. The motor battery 26 can be in electrical communication with the motor 22 and the motor controller 24, the motor controller 24 operable to provide power from the motor battery 26 to the motor 22 to control the motor 22 and the vibrations emitted by the vibrating mechanism 20. In some embodiments, the motor battery 26 may be a conventional battery that can be installed in the pad assembly 12 to supply power to the motor 22 and the motor controller 26. When the capacity of the motor battery 26 is spent, the motor battery 26 can be switched out or replaced with a new battery.

In other embodiments, the motor battery 26 can be a rechargeable battery which can be connected to an external power source or power grid and recharged between uses or when the capacity or charge of the motor battery 26 is expended. In such embodiments, the stimulation device 10 can include a charging element 27 which can be utilized to selectively charge the motor battery 26. The charging element 27 can be positioned or integrated into the pad assembly 12 and/or the pad housing 16 and electrically connected to the motor battery 26. In some embodiments, as shown in FIG. 3, the charging element 27 can be a male charging connector which can extend from the pad housing 16 and be inserted into an external power source. The charging element 27 is shown as a universal serial bus (USB) connector which can be inserted into a suitable USB adapter plug to charge the motor battery 26 from a conventional electrical outlet. The USB connector could also be connected to the USB port of a laptop, computer, car charger, or other similar device that could provide power to the motor battery 26. In other embodiments, the charging element 27 could be a conventional two or three prong male connector for a conventional electrical outlet that could connect directly to the electrical outlet. In still other embodiments, the charging element 27 could be a charging port that could receive a male connector for a charger or other charging adapter, the charger or charging adapter connectable to an electrical outlet or other device to provide power to the motor battery 22.

In some embodiments, the pad assembly 12 can include a charging element cover 29 which can be selectively disposed on the pad housing 16 over the charging element 27. In those embodiments where the charging element 27 is a male charging connector, the charging element cover 29 can include a charging connector recess 31 which can receive the male charging connector when the charging element cover 29 is positioned over the charging element 27 in the pad housing 16. The charging element cover 29 can also include one or more engagement elements 33a which can be engaged with corresponding engagement elements 33b on the pad housing 16 to secure the charging element cover 29 on the pad housing 16. In some embodiments, engagement elements 33a and 33b can be pairs of corresponding recess and protrusions, the protrusions 33a being insertable into the recesses 33b to secure the charging element cover 29 to the pad housing 16. In some embodiments, a friction fit can be produced between corresponding engagement elements 33a and 33b to help retain the charging element cover 29 on the pad housing 16. The protrusions 33a are shown on the charging element cover 29 and the recesses 33b are shown in pad housing 16 in FIGS. 3 and 4. In other embodiments, the protrusion and recess configuration shown can be reversed, or each of the charging element cover 29 and the pad housing 16 can include a combination of recesses and protrusions that can be engaged with corresponding recesses and protrusions on the opposing charging element cover 29 or pad housing 16.

In some embodiments, when the charging element cover 29 is placed on the pad housing 16 the charging element cover 29 and the pad housing 16 can form a continuous pad assembly 12 with a smooth transition between the charging element cover 29 and the pad housing 16 which can help conceal the presence of the charging element cover 29 and the charging element 27, which can help increase the aesthetics of the pad assembly 12. Additionally, in some embodiments, the motor battery 26 and the charging element 27 can be positioned in the charging element cover 29, such that the cover 29 can be removed from the pad assembly 12 and connected to an electrical outlet or another device to recharge the motor battery 26, with the remainder of the stimulation device 10 remaining on the pad assembly 12. Such a configuration can allow the more discrete charging element cover 29 to be displayed in an outlet as opposed to the stimulation device 10 itself.

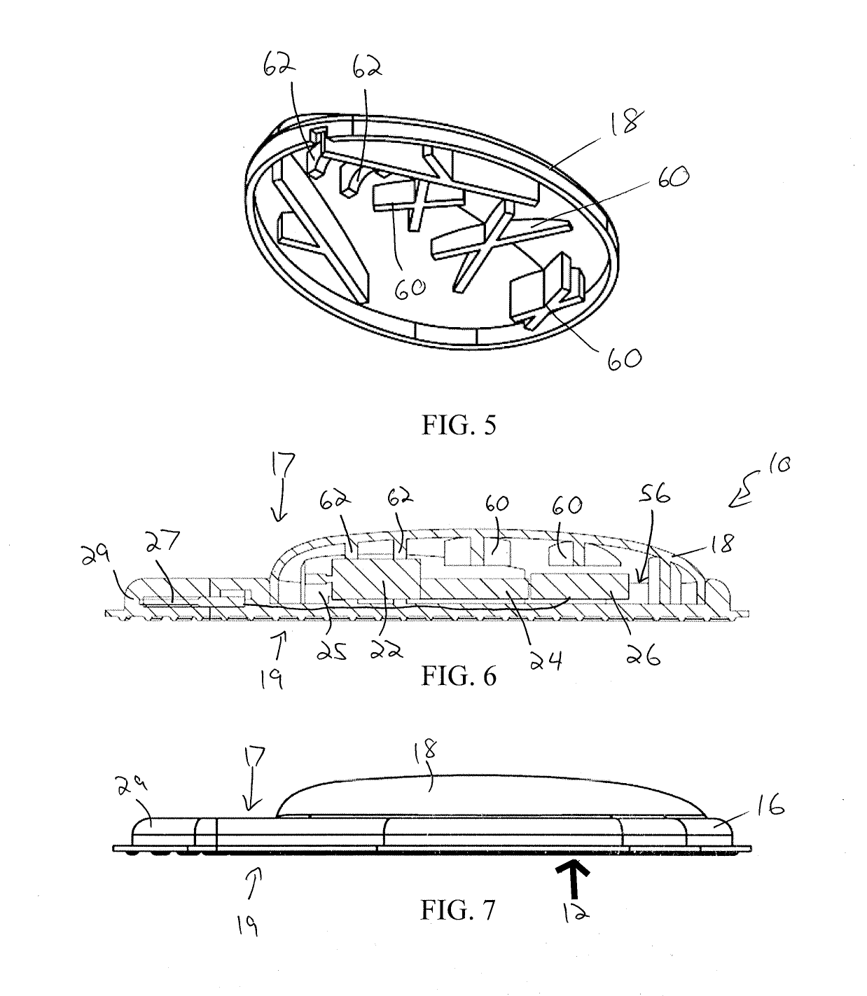

As shown in FIGS. 5-7, a pad 18 can be positioned over and against the vibrating mechanism 20 such that the vibrations emitted by the vibrating mechanism 20 are transferred to the pad 18. The pad 18 can generally be placed against the sexual organs and the user's skin during use of the stimulation device 10. The pad 18 can be made from a flexible or semi-rigid material which can help provide comfort against a user's sexual organs, genitalia, or skin when the stimulation device 10 is used. The pad 18 can be made from any suitable material, including but limited to, rubber, silicone, soft plastics, elastomeric materials, fabrics, etc. In other embodiments, rigid materials such as metals or hard plastics can be utilized for the pad 18. In still other embodiments, the pads 18 can be water or gel filled, the water or gel facilitating the transfer of vibrations throughout the pad 18.

In some embodiments, the pad 18 may extend outwardly from the front side 17 of the pad housing 16 and can have a rounded concave shape. In some embodiments, the pad 18 can be substantially egg-shaped. Having the pad 18 extend outward from the pad housing 16 can allow the vibrating pad 18 to engage or contact the sexual organs of the user without contact from the pad housing 16. The rounded concave or egg shape of the pad 18 can also allow contact from the pad 18 to be concentrated as desired at an apex of the pad 18, for instance on the clitoris of the user, in order to localize or concentrate the stimulation effects of the stimulation device 10 in a desired location on the user.

In some embodiments, the pad 18 can be made from a generally flexible or soft material for comfort. The pad 18 can include a plurality of support ribs 60 on an interior side of the pad 18, with one or more of the support ribs 60 making contact with the vibration mechanism 20 such that vibrations from the vibrating mechanism 20 are transferred to the pad 18 via the one or more support ribs 62 of the plurality of support ribs 60 making contact with the vibrating mechanism. In FIGS. 5 and 6, contact support ribs 62 are shaped to cradle and contact the motor 22 of the vibrating mechanism 20 such that as the vibrating motor 22 is operated, the contact support ribs 62 transfer vibrations emitted by the motor 22 to the pad 18. Additional support ribs 60 provide some rigidity to the more flexible pad 18 to help prevent the vibrations emitted by the vibrating mechanism 20 from dissipating before reaching the outer extremities of the pad 18.

Referring now to FIGS. 3-6, in some embodiments, the pad housing 16 can include a vibrating mechanism recess 56 defined in the front side 17 of the pad housing 16. The vibrating mechanism recess 56 can be sized to receive the vibrating mechanism 20, including one or more of the motor 22, the motor controller 24, and the motor battery 26. In some embodiments, edges of the pad 18 can be inserted into and secured within the vibrating mechanism recess 56 such that the pad 18 covers the vibrating mechanism recess 56 and the vibrating mechanism 20 within the vibrating mechanism recess 56. The pad 18 and the vibrating mechanism recess 56 can have corresponding shapes such that the edges of the pad 18 can form an interference fit with the sidewalls of the vibrating mechanism recess 56. The pad 18 can be deformed by the user to remove the pad 18 from the vibrating mechanism recess 56 to access the vibrating mechanism 20 for repair as needed. Having the vibrating mechanism 20 within a recess formed in the pad housing 16 can help reduce and minimize the overall profile of the stimulation device 10.

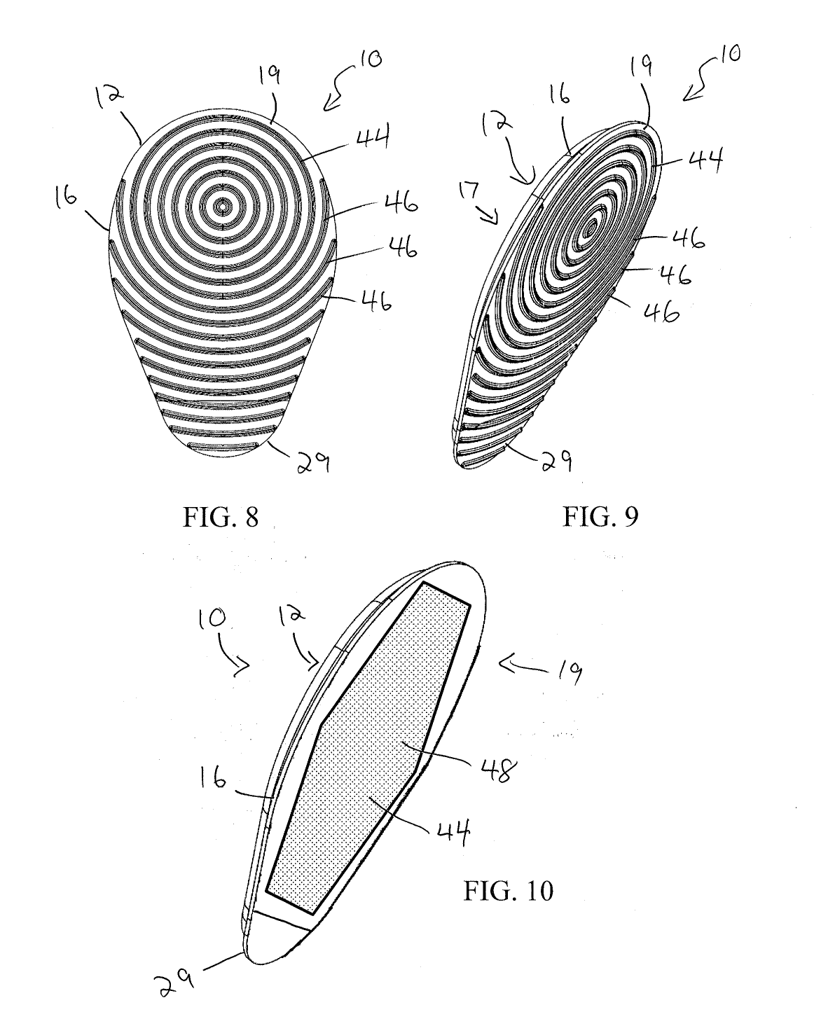

Referring now to FIGS. 8-9, in some embodiments, the back side 19 of the pad housing 16 of the pad assembly 12 can include a retention element 44. The retention element 44 can be configured to help retain the pad assembly 12 in a desired positioned within an undergarment being worn by a user so that the pad assembly 12 and the pad of the stimulation device 10 can remain in a desired location on the user's body or in contact with a desired part of the user's body during use. In some embodiments, the retention element 44 can include a plurality of ridges 46 extending outwardly from the back side 19 of the pad housing 16. The plurality of ridges 46 can be made from a flexible material or a material having a high coefficient of friction such that the ridges can engage the undergarment when the stimulation device 10 is positioned within the undergarment to help retain the stimulation device 10 in a desired position.

In some embodiments, the retention element 44 can be an adhesive layer 48 positioned on the back side 19 of the pad housing 16. In some embodiments, the adhesive layer 48 can cover at least a majority of the back side 19 of the pad housing 16. The adhesive layer 48 can be used to removably affix the stimulation device 10 to an undergarment, and particularly, affix the back side 19 of the pad housing 16 to the undergarment. In some embodiments, the adhesive layer 48 can be a reusable adhesive layer that can be readily attached to an undergarment, and subsequently removed from the undergarment without losing its adhesive properties such that the stimulation device 10 can be affix to a different undergarment. In some embodiments, the adhesive layer 48 can be a medical grade adhesive that can leave little to no adhesive residue on the undergarment when the stimulation device 10 is removed from the undergarment. In some embodiments, the back side 19 of the pad housing 16 can be substantially flat such that substantially all of the adhesive layer 48 can make sufficient contact with the undergarment. Having substantially all of the adhesive layer 48 making contact with the undergarment can help increase the retention of the stimulation device 10 in a desired position on the undergarment.

Referring again to FIGS. 2 and 11-12, in some embodiments, the pad housing 16 when viewed from the front side 17 can have a wider first portion 16a which tapers inward toward a thinner second portion 16b. In some embodiments, the pad housing 18 and/or pad assembly 12 can have rounded edges and longitudinal ends to produce a substantially tear-drop or pear shape. In other embodiments, the pad housing 16 and or ad assembly 12 can have substantially square edges or longitudinal ends, but still have a first wider portion 16a and a second skinner portion 16b.

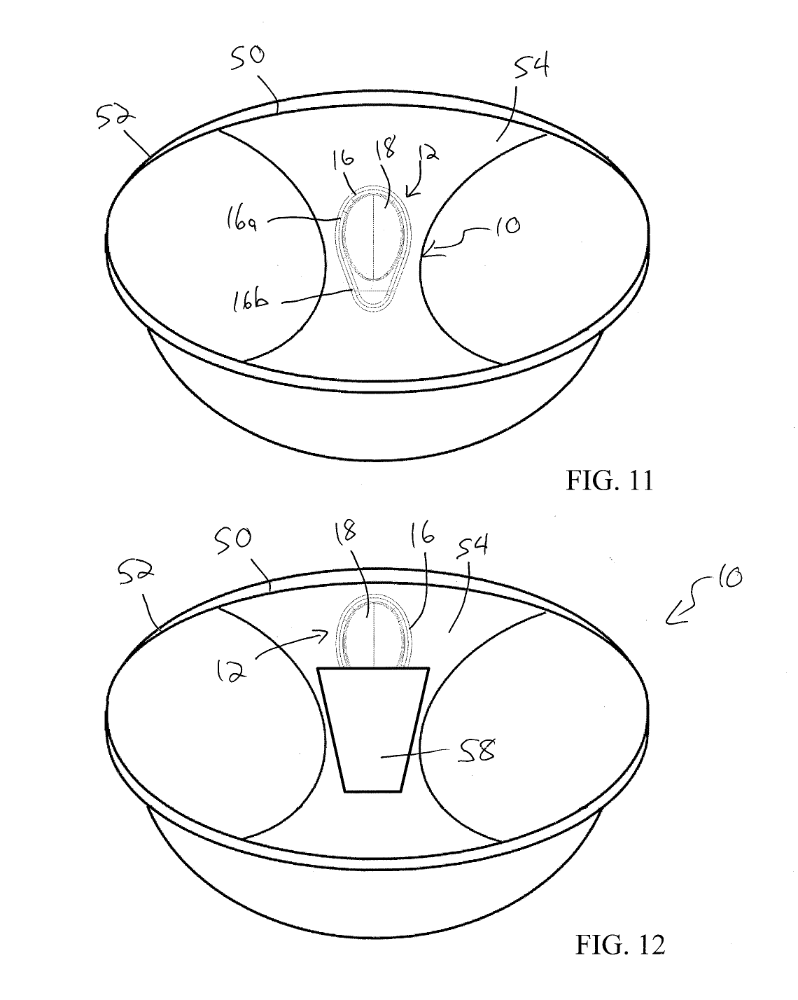

During use, the pad assembly 12 in some embodiments can be placed in an undergarment 50, as shown in FIGS. 11-12, having a waistband 52 and a pelvic covering section 54 generally covering the front of a user's pelvis where the sexual organs are located when the undergarment 50 is worn. In some embodiments, the front pelvic covering section 54 can generally taper inward from the waistband 52 to conform to the inward tapering of the user's pelvis toward the user's crotch. In other embodiments, the undergarment 50 can be boxer or brief style undergarments that have a front pelvic covering section 54 but also have thigh covering portions extending downward from the waistband and adjacent to the front pelvic covering section 54. The pad assembly 12 can be inserted into the undergarment 50 with the thinner second portion 16b of the pad housing 16 oriented in a downward direction and positioned within the pelvic covering region 54 of the undergarment 50 such that the shape of the pad housing 16 generally conforms to the inward tapering shape of the user's pelvis.

With the stimulation device 10 secured to the front pelvic covering section 54 of the undergarment 50, the user can put on the undergarment 50 such that the stimulation device 10 and particularly the pad 18 are positioned against a desired portion of the user's body, for instance the penis in men or the clitoris or vagina in women. The stimulation device 10 can be controlled via the motor control to produce vibrations through the pad 18 which can provide stimulation to the desired sexual organs of the user, thereby increasing arousal and blood flow to the sexual organs. The stimulation device 10 can be used recreationally to increase arousal and blood flow to the sexual organs for sexually active users, or the stimulation device can be used therapeutically by user's who suffer from sexual dysfunction to increase sexual arousal and blood flow to the sexual organs prior to a sexual encounter.

In some embodiments, the stimulation device 10 can include an undergarment 50 designed for the pad assembly 12. The undergarment 50 can include a pocket 58 defined in the front pelvis covering section 54 of the undergarment 50. The pocket 58 can be shaped to receive the pad assembly 12 and retain the pad assembly 12 in a position on the undergarment 50 such that when the undergarment is worn by a user, the pad 18 is positioned against a desired sexual organ or part of the user's body. The pocket 58 can generally be tapered inward toward a crotch of the garment such that the pocket 58 has a shape that corresponds to the shape of the front pelvic covering section 54 and the shape of the pad assembly 12. The pad assembly 12 can additionally include a retention element such as an adhesive layer on the back side of the pad housing 16 as previously discussed to secure the pad assembly 12 within the pocket 58 in the undergarment 50.

The pocket 58 can provide a layer of cloth, fabric, or other soft material between the pad 18 and the user's body to help provide additional comfort during use while providing the benefits from the vibrating effects of the pad 18 through the soft pocket 58. The retention element can also ensure that the pad assembly 12 remains in a desired position and orientation within the pocket 58 and does not slide out of the pocket 58 during use.

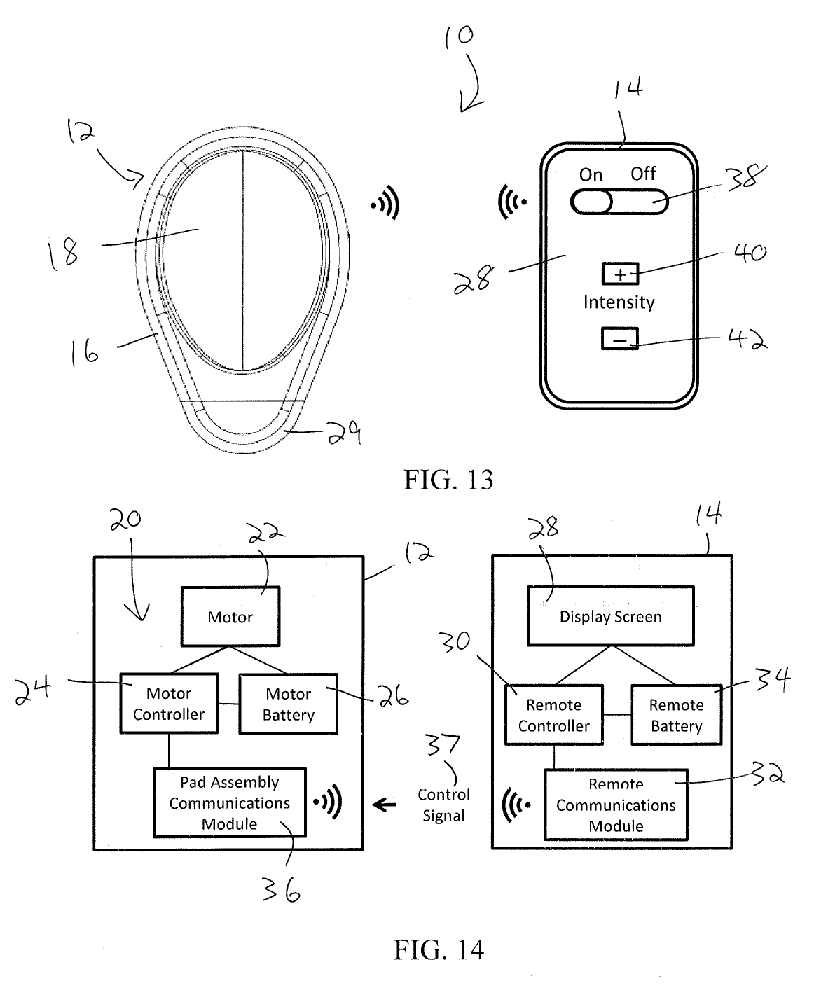

In some embodiments, as shown in FIGS. 13 and 14, the stimulation device 10 can include a remote control 14 which can be operable to control the pad assembly 12 and the vibrating mechanism 20 within the pad assembly 12. The remote control 14 can be communicated with the motor controller 24 such that the remote control 14 can be used to direct and control operation of the motor controller 24, and thus the motor 22 and the vibrations emitted by the vibration mechanism 20 via the motor controller 24.

The remote control 14 can include a remote control controller 30 which can be configured to receive user control inputs. The remote control controller 30 can then communicate a command signal 37 including the user control inputs to the motor controller 24, the motor controller 24 thereby controlling operation of the motor 22 in response to receiving the user control inputs from the remote control controller 30. User control inputs can include turning the motor 22 on and off, varying the speed of the motor 22 and thus the intensity of the vibrations emitted, or the mode of the vibrations (constant versus pulsating vibration modes). The remote control 14 can include a remote control battery 34 which can supply power to the remote control controller 30.

In some embodiments, the remote control 14 can be wirelessly communicated with the motor controller 24. The pad assembly 12 can include a device or pad assembly communications module 36, and the remote control 14 can include a remote control communications module 32. Each of the communications modules 32 and 36 can include one or more wireless antennas which can transmit and receive wireless command signals including user control inputs to facilitate wireless communications between the remote control 14 and the pad assembly 12. The remote control 14 can communicate with the pad assembly 12 using any suitable wireless communication technology, including but not limited to, radio frequency, Bluetooth®, Zigbee, WIFI, or infrared communication technologies.

In some embodiments, the remote control 14 can include a display screen 28 in communication with the remote control controller 30. The remote battery 34 can supply power to the display screen 28 as well as the remote control controller 30 and the remote communications module 32. The display screen 28 can display different user control input choices and/or the current settings for the motor 22 on the pad assembly 12 so that a user can control the vibrations produced in the vibrating mechanism 20 in the pad assembly 12. In some embodiments, the display screen 28 can include a touchscreen or other input device, such that the user control inputs can be selected and received by the remote control controller 30 via the display screen 28. For example, as shown in FIG. 13, the display screen 28 may display an on/off switch 38, which may be used by a user to turn the pad assembly 12 on and off. When the user slides the switch from left to right, the controller 30 generates an off control signal and sends that control signal to the remote communication module 32 for transmission to the pad assembly communications module 36, wherein the motor 22 is stopped. The motor 22 operation can be resumed when the user slides the switch from right to left and produces an on control signal which is sent to the pad assembly communications module 36, wherein the motor 22 is turned back on.

The display screen 28 may display an increase intensity button 40 and a decrease intensity button 42. When a user presses the increase intensity button 40, the controller 30 generates an increase control signal that causes the motor 22 in the pad assembly 12 to operate faster and produce faster and more intense vibrations. Similarly, when a user presses the decrease intensity button 42, the controller 30 generates a decrease control signal that causes the motor 22 to operate more slowly and produce slower and less intense vibrations.

In some embodiments, the remote control 14 can be a mobile electronic device such as a smartphone or tablet. The remote control controller 30 can include a mobile application including a non-transitory computer readable medium having computer program instructions residing thereon. The computer program instructions can be executable by a processor on the mobile electronic device 14 to direct operations further including receiving a control input from a user and transmitting the control input to the pad assembly communications module 36 and the motor controller 24 via the remote communications module 32. As such, a mobile device application or program can be provided specifically to control operation of a stimulation device 10 provided herein. The mobile application can be downloaded on a user's mobile device and synced or linked with a specific stimulation device 10 associated with the user such that the user can control the specific stimulation device 10 using the user's mobile device.

Having a remote control 14 for the stimulation device 10 can allow a user to control the stimulation device 10 via a remote as opposed to controlling the stimulation device 10 with inputs or switches on the device itself, though this disclosure is not limited to devices with remote controls, and some devices 10 can include switches or control inputs on the pad assembly 12 or pad housing 16 that can be used to control the vibrating mechanism 20. Additionally, a remote control that is wireless communicated with the pad assembly can remove the need for cumbersome and awkward wires extending between the remote and the pad assembly, which can be inconvenient and uncomfortable when a stimulation device is worn inside an undergarment. Having a wireless remote 14 can also allow the stimulation device 10 to be controlled from afar, for instance by a partner.

The stimulation device 10 in the present disclosure can provide effective stimulation of the sexual organs of a user which can help increase sexual arousal and blood flow to the sex organs of the user. The user can be a recreational user or a user suffering from sexual dysfunction. The retention elements on the pad housing and the wireless remote control can allow the stimulation device to be used in or affixed to a variety of different undergarments and controlled wirelessly, which can provide convenience for the user.

Thus, although there have been described particular embodiments of the present invention of a new and useful SEXUAL STIMULATION DEVICE, it is not intended that such references be construed as limitations upon the scope of this invention.

What is claimed is:

1. A stimulation device, comprising:
a pad assembly including a pad housing having a front side and a back side;
a vibrating mechanism positioned on the front side of the pad housing, the vibrating mechanism including a motor and a motor controller connected to the motor for controlling the motor and thus vibrations emitted by the vibrating mechanism;
a pad positioned over and against the vibrating mechanism such that vibrations emitted by the vibrating mechanism are transferred to the pad; and
a retention element positioned on the back side of the pad housing.

2. The stimulation device of claim 1, further comprising:
a remote control configured to wirelessly communicate with the motor controller, the remote control including a remote control controller, and a remote control communications module;
wherein the remote control controller is configured to send control signals to the motor controller via the remote control communications module to control the motor and thus vibrations emitted by the vibration mechanism.

3. The stimulation device of claim 2, wherein the remote control further comprises a display screen in electrical communication with the remote control controller, wherein the display screen is configured to receive one or more user control inputs.

4. The stimulation device of claim 2, wherein the remote control is operable to vary the intensity of the vibrations emitted by the vibration mechanism.

5. The stimulation device of claim 1, wherein the retention element comprises a reusable adhesive layer covering at least a majority of the back side of the pad housing.

6. The stimulation device of claim 1, wherein the retention element includes a plurality of ridges extending outwardly from the back side of the pad housing.

7. The stimulation device of claim 1, wherein the vibrating mechanism further comprises a motor battery in electrical communication with the motor and the motor controller, the motor battery selectively providing power to the motor and the motor controller.

8. The stimulation device of claim 1, wherein the back side of the pad housing is substantially flat.

9. The stimulation device of claim 1, further comprising:
a vibrating mechanism recess defined in the front side of the pad housing,
wherein the vibrating mechanism is positioned within the vibrating mechanism recess and the pad covers the vibrating mechanism recess.

10. The stimulation device of claim 1, wherein the motor is a vibrational motor having a motor shaft operable to drive an unbalanced eccentric mass which causes the motor to vibrate when the motor shaft is rotated.

11. The stimulation device of claim 1, wherein the pad includes a plurality of support ribs on an interior side of the pad, at least one of the support ribs positioned against the motor for transferring vibrations from the motor to the pad.

12. The stimulation device of claim 1, wherein the pad assembly when viewed from the front side of the pad housing is substantially tear-drop or pear shaped, the pad assembly having a wider first portion which tapers inward to a thinner second portion.

13. The stimulation device of claim 1, wherein the motor battery is a rechargeable battery, and the device further comprises a charging element in electrical communication with the motor battery, the charging element configured to selectively provide power to the motor battery.

14. The stimulation device of claim 1, wherein the pad extends outwardly from the front side of the pad housing and has a concave, rounded outer surface.

15. A stimulation device, comprising:
a pad assembly including a pad housing having a front side and a back side;
a vibrating mechanism positioned on the front side of the pad housing, the vibrating mechanism including a motor and a motor controller connected to the motor for controlling the motor and thus vibrations emitted by the vibrating mechanism;
a pad positioned over and against the vibrating mechanism such that vibrations emitted by the vibrating mechanism are transferred to the pad;
a remote control wirelessly communicated with the motor controller, the remote control operable to control the motor controller and thus vibrations emitted by the vibrating mechanism; and
a retention element positioned on the back side of the pad housing.

16. The stimulation device of claim 15, wherein the remote control further comprises:
a remote control controller configured to receive user control inputs; and
a remote communications module in communication with the remote control controller, the remote communications module configured to transmit a control signal including the user control inputs to the motor controller to control the vibrations emitted by the vibrating mechanism.

17. The stimulation device of claim 15, wherein the remote control is a mobile electronic device and the remote control controller is a mobile application including a non-transitory computer readable medium having computer program instructions residing thereon and executable by a processor on the mobile electronic device to direct operations further comprising:
receiving a control input from a user; and
transmitting the control input to the motor controller via the remote communications module.

18. A stimulation device, comprising:
a pad assembly including a pad housing having a front side and a back side;
a vibrating mechanism positioned on the front side of the pad housing, the vibrating mechanism including a motor and a motor controller connected to the motor for controlling the motor and thus vibrations emitted by the vibrating mechanism;
a pad positioned over and against the vibrating mechanism such that vibrations emitted by the vibrating mechanism are transferred to the pad;
a remote control wirelessly communicated with the motor controller, the remote control operable to control the motor controller, the motor, and thus vibrations emitted by the vibrating mechanism; and
a reusable adhesive layer positioned on the back side of the pad housing.

19. The stimulation device of claim 18, further comprising:
an undergarment having a waistband and a pelvic coverage portion; and
a pocket on the pelvic coverage portion, the pocket sized to receive the pad assembly;
wherein the reusable adhesive layer can be adhered to the pelvic coverage portion of the undergarment to secure the pad assembly to the pelvic coverage region within the pocket.
